(19) United States
(12) Patent Application Publication
(10) Pub. No.: US 2007/0076780 A1
(43) Pub. Date: Apr. 5, 2007

(54) Devices, systems and methods for determining temperature and/or optical characteristics of a substrate

(76) Inventor: Robert J. Champetier, Depoe Bay, OR (US)

Correspondence Address: JONES DAY, 222 EAST 41ST ST, NEW YORK, NY, 10017, US

(21) Appl. No.: 11/241,579

(22) Filed: Sep. 30, 2005

(51) Int. Cl. G01J 5/00; G01K 11/00

(52) U.S. Cl. 374/121; 374/141; 374/161

(57) ABSTRACT

A system for measuring the true temperature of a substrate in a deposition system is disclosed. The temperature measurement system has at least one opening formed within a showerhead or manifold placed above a substrate of the deposition system. The temperature measurement system includes an optical pyrometer and reflectometer external to the coating chamber that looks through a window or windows and through the at least one opening in the showerhead to sense the substrate being coated. Depending on the particular chamber and showerhead configuration, the system either makes a passive emissivity correction or has an integral reflectometer for an active emissivity correction. Optical features confer an insensitivity to small motions of the showerhead in large coaters where optical alignment is not assured due to thermal and mechanical influences.

### CROSS-REFERENCE TO RELATED APPLICATIONS

This non-provisional application is related to U.S. patent application Ser. No. 10/616,254 of Robert J. Champetier, entitled “Emissivity Corrected Radiation Pyrometer Integral with a Reflectometer and Roughness Sensor for Measuring True Surface Temperatures at a Distance from the Sample,” which was filed on Jul. 8, 2003, and to U.S. Provisional Application No. 60/397,200 of Robert J. Champetier, which was filed on Jul. 19, 2002, each of which is incorporated herein in its entirety by this reference.

### FIELD OF THE INVENTION

This invention generally relates to devices, systems and methods of determining the temperature and/or optical characteristics of a substrate or surface, such as a substrate or surface upon which a material is deposited or a substrate or surface that undergoes any change, such as a physical or chemical change, that might alter its thermal emissivity. More particularly, this invention relates to such devices, systems and methods that can be used to determine the temperature and/or optical characteristics of a substrate while a material is being deposited on its surface or a substrate undergoing a process that alters its surface emissivity.

### BACKGROUND OF THE INVENTION

In the manufacturing of various substrates, such as substrates for flat panel displays (FPD), metal organic chemical vapor deposition (MOCVD) devices, coating glass, and organic light-emitting device (OLED) displays, for example, various materials, layers or films are deposited on the substrates. There are a variety of approaches and methods that are used in the deposition of such materials, including chemical vapor deposition (CVD), low-pressure CVD (LPCVD), plasma-enhanced CVD (PECVD), vapor phase epitaxy (VPE), metalorganic CVD (MOCVD), physical vapor deposition (PVD), molecular beam epitaxy (MBE), and other deposition methods. Such methods are described in Van Zant, 2000, Microchip Fabrication, McGraw-Hill, New York; Handbook of Microlithography, Micromachining, and Microfabrication, Rai-Choudhury ed. 1997, The Society of Photo-Optical Instrumentation Engineers, Bellingham, Wash.; Levinson, 2001, Principals of Lithography, The Society of Photo-Optical Instrumentation Engineers, Bellingham, Wash.; and Madou, Fundamentals of Microfabrication, The Science of Miniaturization, Second Edition, 2002, CRC Press LLC, Boca Raton, Fla., each of which is hereby incorporated by reference in its entirety. The methods and systems used to deposit such materials are of various types, several of which employ manifolds or showerheads for the delivery of gas or gases that are used in the deposition process. These manifolds or showerheads are typically situated over the substrates, or over the surfaces of the substrates that are to be coated.

Uniform and precise control of the temperature of the substrates during the deposition process is generally required. In the absence of an obstacle such as a manifold or showerhead, an optical pyrometer may be used to measure the brightness temperature, also known as the apparent temperature, of a smooth or polished surface. Means for measuring the brightness temperature are well known and include various commercially available optical pyrometers of various designs from several manufacturers. Once the brightness temperature is obtained, it is corrected based on the emissivity of the radiating surface of the substrate to obtain the true temperature. Generally, the emissivity for a given surface material is found in a reference or is measured separately using another instrument, provided the emissivity is known to remain constant during the deposition process being monitored. An example of an instrument that is often employed for the emissivity measurement is one that relies on concurrent pyrometry and reflectometry. Previously, such a pyrometer-reflectometer instrument has functioned properly only in the absence of an obstacle between the pyrometer and the substrate being measured. As such, a pyrometer-reflectometer instrument has not heretofore been suitable for use in connection with a deposition system that has a manifold or showerhead that may present such an obstacle.

When using a deposition system that has a manifold or showerhead, it is often desirable to determine not only the temperature of the substrate being processed, but also the temperature of the showerhead near the substrate. It is often difficult to measure the true temperature of a substrate during such a deposition process using simple pyrometry, such as optical pyrometry, for a number of reasons. One reason is that, as a material is being deposited on a surface of a substrate, the emissivity of the surface is generally affected by the presence of the deposited material. As such, the emissivity applicable during the deposition process is not known, and hence, the pyrometrically determined brightness temperature cannot be corrected to provide the true temperature. Another reason is that the presence of a manifold, a showerhead, and/or a plasma in the deposition system generally interferes with the corrective capability of the pyrometer, even when the pyrometer is a modern one of some sophistication that can measure emissivity and apply an appropriate temperature correction to such a measurement. This interference reduces the reliability of the temperature reading obtained from such a system.

Currently, production tools and processes are being developed for the efficient and scaled-up manufacture of flat panel display (FPD), and organic light-emitting diode (OLED) based devices. By way of example, some of these tools and processes can be used to coat several FPD substrates at once using CVD techniques. Similar progress is being made in the fabrication of OLED displays. For optimum control of such multi-substrate processes, it is desirable to determine the temperature distribution within the production tool or system over a large area. However, it is often difficult to obtain this temperature distribution using simple pyrometry, such as optical pyrometry, for various reasons.

For example, optical pyrometry systems and methods typically operate using vacuum windows in the walls of the processing chamber, as well as holes or other orifices inside the processing chamber, that provide an optical pathway between the pyrometer and the substrate. Schemes for obtaining pyrometric measurements from the exposed front side of a substrate, such as a glass sheet, for example, are often not acceptable, as that front side becomes coated during a deposition process. As mentioned above, the coating generally affects the emissivity of the surface during the deposition process. Thus, a pyrometric reading obtained from the front side of the substrate during a deposition process typically does not correspond to that for the bare, uncoated substrate, and a known, fixed temperature correction based on the emissivity of the surface of the substrate is not applicable. Further, schemes for obtaining pyrometric measurements, such as those associated with infrared pyrometry, from the uncoated backside of the substrate during the deposition process, are not acceptable. These schemes are typically carried out using certain tools that are designed so that the substrate to be coated, such as a glass sheet, for example, is placed with its backside resting on a heated plate during deposition. Holes or other orifices in the plate and adjacent to the underside of the substrate provide an optical pathway between the pyrometer and the underside of the substrate for pyrometric measurements. Unfortunately, these holes or orifices adjacent to the underside of the substrate can cause local imperfections in the finished devices that are undesirable or unacceptable.

Further development of devices, systems and methods of assessing the temperature and; or optical characteristics of substrates during a deposition process is desirable.

### SUMMARY OF THE INVENTION

In accordance with the present invention, there is provided a system for measuring the temperature of a substrate in a deposition system. The temperature measurement system has at least one opening formed within a showerhead or manifold of the deposition system. The showerhead or manifold is placed above the substrate. Furthermore, the temperature measurement system has an opening or window formed within a wall of the deposition system. An optical temperature measuring device such as a pyrometer or reflectometer is in optical communication with the opening formed in the wall of the deposition system and the opening formed in the showerhead. In this regard, an optical pathway is formed between the optical temperature measuring device and the surface of the substrate. The optical temperature measuring device is configured to measure the temperature of the substrate using the optical pathway.

It is possible to use multiple optical temperature measuring devices with the optical pathway in order to measure the temperature of the substrate. Furthermore, it is possible to form multiple openings or windows within the wall of the deposition system and have an optical temperature measuring device measuring the temperature of the substrate through each window or opening.

The optical temperature measuring device may have a light source and a detector. The light source generates a light ray onto the surface of the substrate with the optical pathway, while the detector receives a reflected light wave from the surface of the substrate. The reflected light wave can be used to measure the temperature of the substrate.

### BRIEF DESCRIPTION OF THE DRAWINGS

A detailed description of various aspects, features and embodiments of the present invention is provided herein with reference to the accompanying drawings, which are briefly described below. The drawings are illustrative and are not necessarily drawn to scale. The drawings illustrate various aspects or features of the present invention and may illustrate one or more embodiment(s) of the present invention in whole or in part. A reference numeral or symbol that is used in one drawing to refer to a particular element or feature may be used in another drawing to refer to a like element or feature.

FIG. 1A is a schematic, side-view illustration of a deposition system, an associated optical system, and an associated data processing system, according to an embodiment of the present invention. FIG. 1B is a schematic, side-view illustration of a portion of a deposition system and associated optical system, according to an embodiment of the present invention. FIG. 1C is a schematic, side-view illustration of a portion of a deposition system and associated optical system, according to an embodiment of the present invention. FIGS. 1A-IC may be referred to collectively herein as FIG. 1.

FIG. 2A is a schematic, top-view illustration of a portion of a showerhead of a deposition system, and a region thereof, as seen by a pyrometer, according to an embodiment of the present invention. FIG. 2B is a schematic, top-view illustration of a portion of a showerhead of a deposition system, and a region thereof, as seen by two pyrometers, according to an embodiment of the present invention. FIGS. 2A-2B may be referred to collectively herein as FIG. 2.

FIG. 3 is a graphical representation of the reflectivity of light by a smooth, aluminum surface versus the angle of incidence of the light, as measured relative to a direction normal to the surface, as further described in relation to an analysis provided herein.

FIG. 4 is a graphical representation of the effective emissivity of a radiating surface when passive emissivity enhancement is utilized by forming a cavity consisting of the radiating surface and a highly reflective surface close to the emitting surface. The figure shows the effective emissivity versus the emissivity of the same surface without enhancement. The several lines represent calculations of enhanced emissivity for four values of the reflectivity of the surface forming the cavity: line 4A is for a reflectivity of 0.90, line 4B is for a reflectivity of 0.88, line 4C is for a reflectivity of 0.86, and line 4D is for a reflectivity of 0.84, as further described in relation to an analysis provided herein.

FIG. 5 is a graphical representation of the calculated net transmittance of radiation emitted by a hot substrate as the radiation passes through a tube in a showerhead versus the reflectivity of the surface of the showerhead, as further described in relation to an analysis provided herein.

FIG. 6A is a schematic, side-view illustration of portions of a deposition system and an associated optical system, according to an embodiment of the present invention. FIG. 6B is a schematic, side-view illustration of portions of a deposition system and an associated optical system, according to an embodiment of the present invention. FIGS. 6A-6B may be referred to collectively herein as FIG. 6.

### DETAILED DESCRIPTION

This invention is generally directed to a pyrometric device and/or system for use in determining the temperature and/or optical characteristics of a substrate. The invention is also directed to a method associated with such a device or system, for depositing or forming a material on a substrate.

In the description of the invention herein, it will be understood that a word appearing in the singular encompasses its plural counterpart, and a word appearing in the plural encompasses its singular counterpart, unless implicitly or explicitly understood or stated otherwise. Further, it will be understood that for any given component described herein, any of the possible candidates or alternatives listed for that component, may generally be used individually or in combination with one another, unless implicitly or explicitly understood or stated otherwise. Additionally, it will be understood that any list of such candidates or alternatives, is merely illustrative, not limiting, unless implicitly or explicitly understood or stated otherwise.

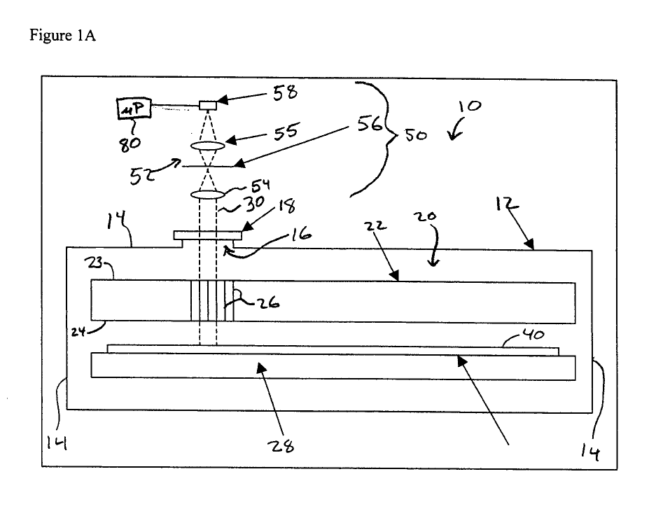

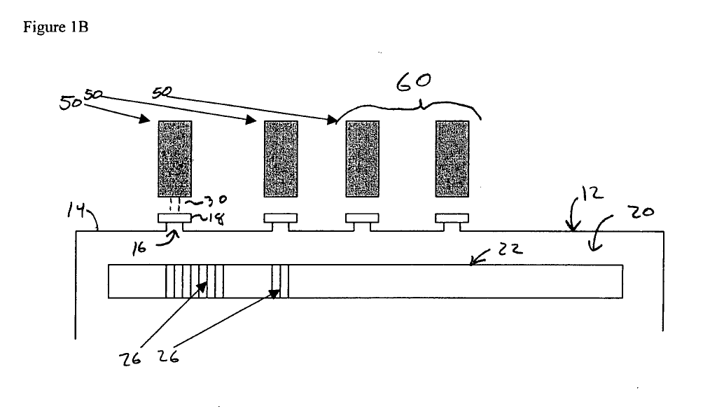

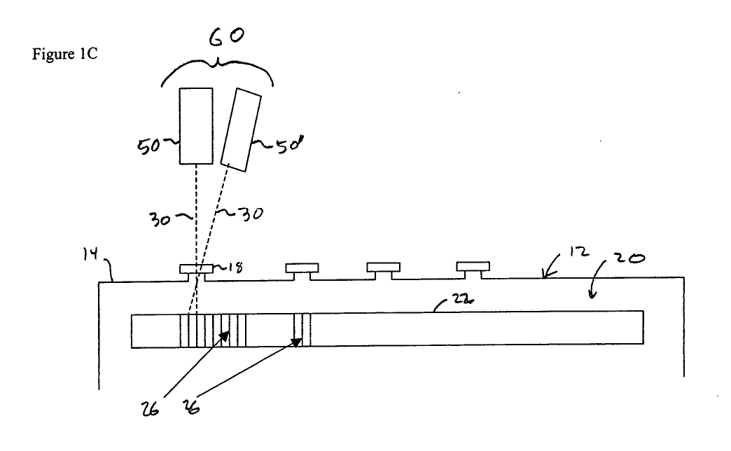

A system for depositing a material on a substrate is depicted in FIG. 1A. The system 10 typically includes a chamber 12 with its chamber walls 14, a window opening 16 in at least one of the chamber walls 14, a window 18 disposed in or adjacent the window opening 16, a plenum chamber 20 above a manifold or showerhead 22, a manifold or showerhead 22 for providing gas above a substrate 40, and a support, plate or platen 28 for supporting, and possibly heating, a substrate 40. The system also includes any of several means that are not detailed in FIG. 1A, such as the following: means or devices for controlling a pressure within the chamber, means or devices for supplying gas to the chamber, such as an external gas supply, means or devices for controlling the supply of gas to the chamber, such as a mass flow controller, means or devices for exhausting gas from the chamber, means or devices for heating the platen, and the like, and any combination thereof.

The deposition system 10 is designed to deliver the gases in a controlled manner so as to achieve any desirable result, such as uniformity and/or quality of the finished substrate or device, merely by way of example. In a typical deposition system 10, substrate 40 is placed on platen 28, as shown in FIG. 1A. In any given application, substrate 40 may be heated at any suitable time and to any suitable temperature. By way of example, after substrate 40 is placed on platen 28, the substrate may be allowed to reach, or may be heated to reach, a suitable process temperature. This process may take anywhere from a short period to long period, depending on a variety of factors, such as the particularities of the system used, the starting temperature of the substrate, the method and devices used in the heating process, and/or the like. By way of example, in the case of a process used to produce a flat panel display, a glass substrate is placed over a pre-heated heating platen and allowed to reach adequate temperature uniformity. The process generally results in the formation of different layers on the substrate via different reactive gases and chemistries. As such, the platen or substrate temperature may be selected as any suitable temperature for the formation of a particular layer on the substrate, may be varied to any suitable temperature for the formation of a different layer on the substrate, and the like. Thus, the platen or substrate temperature may be changed periodically, preferably in a manner to achieve a quick and uniform change in the temperature of the substrate, prior to the introduction of reactive gas or particular chemistry, or prior to a change in reactive gas or chemistry.

Once substrate 40 is placed on platen 28, and either heated or not heated, as appropriate, process gas or gases are introduced into plenum chamber 20 of deposition system 10 via external supplies, mass flow controllers, and the like. The gas then passes through openings 26 in manifold or showerhead 22 toward the volume or area above substrate 40. The gas manifolds 22, usually referred to as showerheads 22, that are used to provide a process gas or process gases in the vicinity of substrate 40, vary in design.

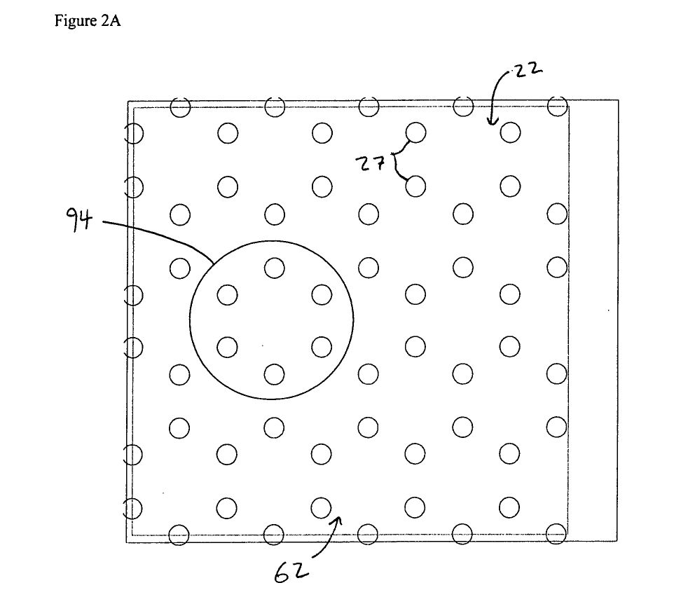

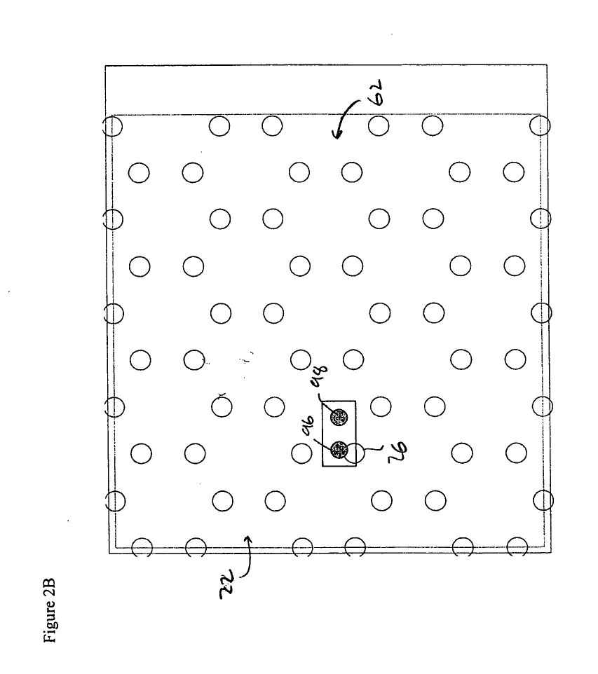

A great variety of showerhead configurations are possible and contemplated as being within the context of the present invention. Merely by way of example, a showerhead 22 may be made of metal, such as stainless steel or aluminum, for example, glass, such as fused silica, for example, and/or various other materials, and may be quite thick. In certain systems, showerhead 22 may have a large number of tubular passageways 26, for example as a large number of thin tubes 26 that are closely packed, such as in a honeycomb pattern, as depicted in FIG. 1A. In certain other systems, showerhead 22 may have a large number of perforations 27, such as a large number of well-separated cylindrical holes 27 arranged in a regular geometric pattern 62, such as a square or a hexagonal pattern, as depicted in FIG. 2A and FIG. 2B. Merely by way of example, the separation between adjacent perforations 27 may range from about the diameter of a single perforation to as much as several such diameters. Further, by way of example, the diameter of a single tube 26 or perforation 27 may be from about 1 mm to about 20 mm for a particular tool design.

In the above-described deposition systems, variables for controlling the deposition process generally include the geometry of the system components, such as the chamber and the showerhead, the pressure in the chamber, the mass flow rate of the gas or gases, the temperature of system components, such as the showerhead, and the temperature of the substrate. These variables differ from system to system. By way of example, in some systems, the temperature of the showerhead may differ from that of the substrate and may be cooler by tens or even hundreds of degrees. Cleanliness of the system and its components, such as the showerhead, is important and should be routinely maintained. By way of example, preferably, the surface of a metal showerhead is shiny or polished and the surface of a glass or a quartz showerhead is visibly clear.

Instrumentation for determining the true temperature and/or optical characteristics of the substrate in a deposition system, and/or for determining the temperature and/or optical characteristics of the showerhead in a deposition system, should meet typical system requirements. By way of example, preferably, such instrumentation does not affect the performance of, or intrude into, the fabrication system or its components. As such, optical instrumentation that is external to the chamber is preferred. For example, as shown in FIG. 1A, a window 18 that provides an optical pathway 30, such as a pathway for infrared light, may be provided in a wall 14 of chamber 12, such that optical instrumentation external to the chamber may be used.

According to an embodiment of the invention, a deposition system 10, such as that shown in FIG. 1A, is provided. The deposition system 10 comprises one or more showerhead(s) 22, each having tubular passageways 26 or well-separated perforations 27, and other features as previously described in relation to FIG. 1 and FIG. 2. The deposition system 10 further comprises a first pyrometer 50 having an optical system 52 that comprises an objective lens 54, a relay lens 55, a field aperture 56, and a detector 58, as shown in FIG. 1A. The objective lens 54 and the relay lens 55 may be used to control the size and shape of the area that is seen by the pyrometer via the field aperture 56. The field aperture 56 may be used to choose which portion of the thermal radiation from the showerhead 22 is relayed to detector 58 and to ensure that thermal radiation from substrate 40 is efficiently passed through showerhead tubes 26 or perforations 27 to detector 58. System 10 additionally comprises a signal processor 80, such as a microprocessor (μP). In some embodiments, signal processor 80 is one or more application specific integrated circuits (ASICs) and/or field-programmable gate arrays (FPGAs). In some embodiments, signal processor 80 is implemented as one or more digital signal processors (DSPs). In such embodiments, signal processor 80 is realized as any combination of chips, including any combination of ASICs, FPGAs, DSPs, or other forms of microchips known in the art. Signal processor 80 is in operable communication with one or more detector(s) 58, for receiving one or more electrical signal(s) from one or more detector(s) 58, and for manipulating the signal(s), such as via hardware, software, and/or algorithm(s), to provide desirable output, such as an indication of temperature.

In this embodiment, one or more infrared pyrometers 50 are disposed outside of the chamber 12 and are directed at one or more corresponding appropriate windows 18 external to plenum chamber 20, as shown, for example, in FIG. 1B. Infrared pyrometers 50 may be grouped to make up one or more sets 60 of pyrometers, such as a set of two pyrometers, a set of three pyrometers, a set of four pyrometers, two sets of two pyrometers, and/or the like. Each set 60 consists of at least two pyrometers 50, the signals from which are processed to obtain desired temperatures, as further described below. Optical system 52 of a first pyrometer 50 is configured or designed such that it is or may be directed at the optical pathways 30 through a number of tubes 26 or orifices 27 in the showerhead 22 at the same time. Herein, a pyrometer, a set of pyrometers, an optical system, or any components thereof may be described using visual terms or the like. By way of example, pyrometer 50, the set 60 of pyrometers 50, the optical system 52, and/or any component thereof may be described as “looking through” tubes 26 or orifices 27 in the showerhead 22 “to see” (monitor the temperature of) substrate 40.

The operating wavelength range of pyrometer 50 may be chosen. By way of example, a pyrometer 50 having an operating wavelength range of from about 8 μm to about 14 μm may be appropriate and convenient for low temperature applications, such as those starting at about ambient temperature to less than about 500° C., for example, and may operate without interference from possible plasmas in the chamber. Further by way of example, a pyrometer 50 having an operating wavelength range in the indium gallium arsenide (InGaAs) detection range of less than about 1.7 μm may be appropriate for higher temperature applications, such as those starting at about 100° C., for example. Still further by way of example, a pyrometer 50 having an operating wavelength range in the silicon detection range of less than about 1.1 μm may be appropriate for even higher temperature applications, such as those starting at about 300° C., for example. Other operating wavelengths are possible, such as those associated with known laser, laser diode, and/or light-emitting diode (LED) devices. By way of example, operating wavelengths may be chosen so as to monitor additional parameters, such as the reflectivity of the substrates at selected light-emitting diode (LED) or laser wavelengths. Further, by way of example, operating wavelengths may be selected via a combination of broadband light sources and optical bandpass filters, monochromators, and/or polychromators.

Showerhead 22 and substrate 40 are in sufficient proximity such that a blackbody cavity or an approximate blackbody cavity, of suitable approximation, is formed. A blackbody cavity or an approximate blackbody cavity may be formed by selecting a gap between the bottom surface 24 of the showerhead 22 and the exposed surface of substrate 40 that is a suitable fraction of the lateral dimensions of showerhead 22, such as about 0.05 or about 0.025 of the width of the showerhead. The exact geometry and composition of showerhead 22 affects the quality of the resulting blackbody in a predictable manner, and thus, the accuracy of pyrometer 50 as well. Merely by way of example, when measuring the temperature of substrate 40 when the showerhead surface 24 near it is at a different temperature, the degree to which a blackbody cavity is achieved or approximated depends on showerhead 22 surface reflectivity. In such a case, a highly reflective showerhead surface is desirable. By way of example, showerhead 22, including its bottom surface 24, may be composed of metal, such as a highly reflective metal. In such a case, and when the temperature of the substrate 40 is less than about 500° C., the operating wavelength of pyrometer 50 is preferably near about 10 μm, given the high reflectivity of metals in this range of the infrared, to better meet an approximate blackbody condition. During operation, substrate 40 emits thermal radiation that undergoes multiple reflections before passing up through the tubes 26 or orifices 27 in showerhead 22. This thermal radiation is close to that of a blackbody, even though the emissivity of the surface of substrate 40 may be much lower and may undergo changes as film formation on the substrate occurs or continues. The degree to which the cavity approaches the properties of an ideal blackbody cavity can be analyzed so as to compute temperature corrections for use in determining true temperature of substrate 40 with acceptable accuracy.

When the optics 52 of the first pyrometer 50 are directed at the top 23 of the showerhead 22, the “footprint,” or the area seen, corresponds to a selected number of tubes 26 or orifices 27, even if the alignment of the showerhead 22 relative to the pyrometer 50 is changing, for example, because of thermal expansion in the hardware of the chamber 12. During operation, first pyrometer 50 receives radiation from substrate 40 through at least one of tubes 26 or orifices 27 of showerhead 22, radiation from top surface 23 of showerhead 22, as well as radiation from tubes 26 or orifices 27 of showerhead 22. For certain tool designs, the signal from substrate 40 alone and the signal from showerhead 22 alone are roughly comparable in magnitude. In such cases, a second pyrometer 50 is used to detect the direct radiation from the showerhead 22, as further described herein, so that a temperature correction can be applied.

One or more signal(s) from one or more pyrometer detector(s) 58 are transmitted to signal processor 80. Appropriate signal data may be analyzed or processed by signal processor 80 to provide an indication of the true temperature of substrate 40. Further, when direct radiation from showerhead 22 is measured, as described above in relation to a second pyrometer 50, associated signal data may be analyzed or processed by signal processor 80 to provide an indication of the true temperature of showerhead 22. Still further, appropriate signal data may be analyzed or processed by signal processor 80 to provide an indication of the apparent temperature of showerhead 22, which may be converted to a true temperature using an independently determined emissivity for the clean, upper surface 23 of the showerhead.

An analysis concerning the present invention was undertaken. This analysis concerned a deposition system 10, such as that described above in relation to FIG. 1A, wherein a metal showerhead 22 that is disposed above a substrate 40 within a chamber 12 has only a small percentage of its area, such as about 1 percent to about 10 percent, for example, occupied by tubes 26 that are used for gas transport. Upper surface 23 of the showerhead, the lower surface 24 of the showerhead, and the inner walls of the tubes 26 in the showerhead are clean, smooth, and composed of aluminum. This analysis further concerned an associated pyrometer 50, such as that described above in relation to FIG. 1A, that is operated in an infrared wavelength range, such as a range of from about 8 μm to about 12 μm or from about 8 μm to about 14 μm. In this analysis, calculations were carried out for an exemplary wavelength of 10 μm.

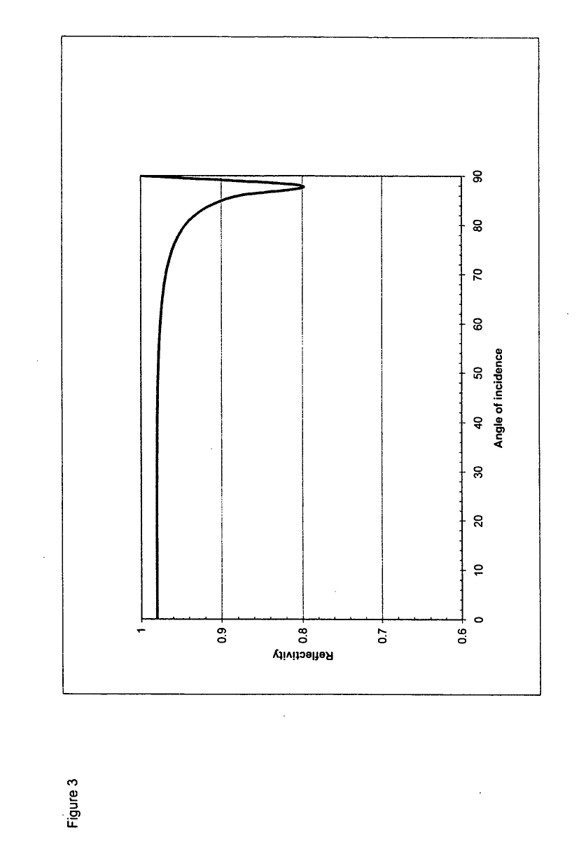

When light of a wavelength of about 10 μm is directed at a metal surface at various angles of incidence, it is variably reflected. At a wavelength of 10 μm, the effect of a lack of perfect smoothness of a metal surface on its reflectivity is minimal compared to what it would be at a much shorter wavelength in the visible range of the electromagnetic spectrum. In this analysis, the reflectivity of 10 μm-wavelength light by a pure, smooth aluminum surface at various angles of incidence of such light, defined relative to a direction normal to the surface, was calculated based on optical properties generally available in handbooks of optical constants or, as in this case, from the tables of optical constants that form part of commercially available thin film computation codes for personal computers, the one used here being the Concise MacLeod version 8.2d. A graphical representation of the reflectivity versus the angle of incidence, according to these calculations, is shown in FIG. 3.

The emissivity of the reflecting cavity between bottom surface 24 of showerhead 22 and the exposed surface of substrate 40 in chamber 12 may be enhanced in a known manner by virtue of the reflectivity of the metal surface 24 of showerhead 22 that is disposed above and parallel to the substrate 40. A higher reflectivity within a reflecting cavity brings about a greater emissivity enhancement for the thermal radiation of substrate 40, even though the bottom surface 24 of the showerhead 22 may be cooler than the substrate. The emissivity enhancement in the reflecting cavity by virtue of the aluminum showerhead 22 was analytically determined in the manner described below.

Consider a substrate such as a hot flat plate radiating with emissivity ε facing a cold reflector with reflectivity ρ, thus the plate and the reflector parallel to each other forming a cavity. The reflector has a small hole through which a small fraction of the radiation within the cavity escapes. We need to know the apparent or effective emissivity ε_{eff} of the radiation coming through the small hole. Consider a ray emitted by the plate with emissivity ε, reflected by the reflector back to the plate an amount ερ, then reflected this time by the plate an amount ερ(1−ε), since the reflectivity of the hot plate is equal to (1−ε). We now have, after a first round trip of the ray, an amount leaving the hot plate equal to ε+ερ(1−ε). Following the ray for a second round trip to the reflector and back bouncing off the plate, we get an additional increment. When we sum up all these contributions which form an infinite series, the series is equal to the effective emissivity of the plate as enhanced by the presence of the reflector, that is equal to: ε_{eff}=ε/[1−ρ(1−ε)] where again, the ε is for the hot plate p is for the reflector. In an actual plate and reflector cavity, some reduction occurs near the edges of the cavity as some of the multiple reflected contributions are lost at the gap at the edge of the cavity. The formula is helpful away from the edges of the cavity.

As the above theoretical considerations indicate, the emissivity of reflecting cavity may be enhanced by virtue of the effect of the aluminum showerhead 22 on substrate 40 within the reflecting cavity. Whereas the reflectivity of a solid aluminum plate would be near 0.98 at a radiation wavelength of 10 μm, the value of this reflectivity must be reduced for purposes of calculating ε_{eff} in the cavity due to the presence of the tubular holes. These have the effect of reducing the average reflectivity in proportion to the area representing the holes in the showerhead.

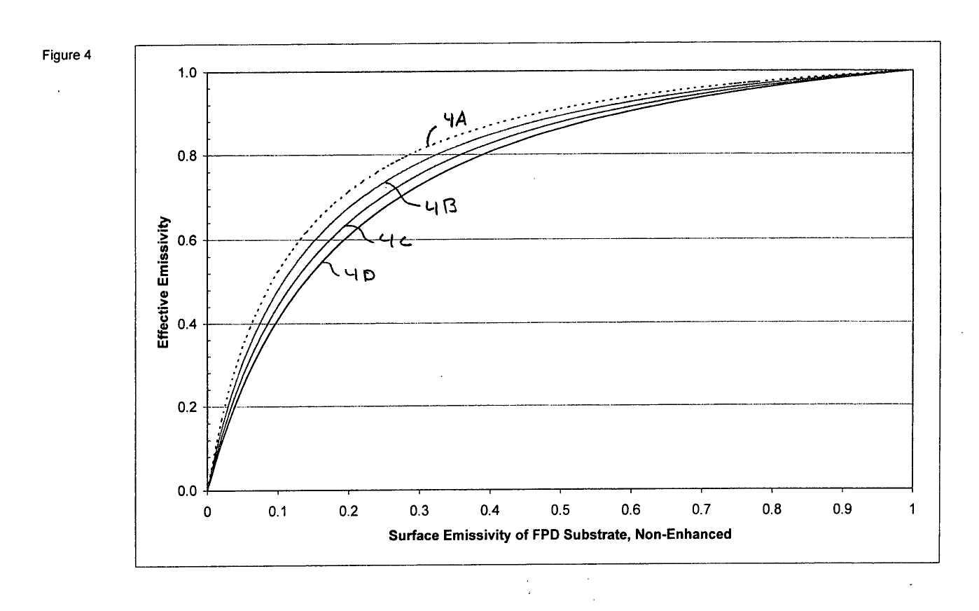

A graphical representation of the effective emissivity ε_{eff} versus the emissivity of the radiating hot substrate is shown in FIG. 4, where lines 4A, 4B, 4C, and 4D represent the situation in which the showerhead surface 24 has a reflectivity of 0.90, 0.88, 0.86, and 0.84, respectively, relative to the 10 μm-wavelength radiation, excluding edge effects. These four values of reflectivity represent four cases of the tubular holes occupying varying fractions of the surface of the reflecting showerhead surface.

It should be noted that initially (e.g., prior to the start of a coating process), a bare glass substrate may have an emissivity typically in the range of about 0.8 to about 0.9, depending on the exact wavelength band pass used for the measurement, as well as the precise composition of the glass, such as the SiO₂ content of the glass, for example. It should further be noted that emissivity values based on those associated with float glass were used in this analysis, although the properties of other glasses are very similar to those of float glass over a wavelength range of about 8 μm to about 14 μm. Merely by way of example, an emissivity of float glass near a wavelength of about 10 μm may be taken to be about 0.85.

As demonstrated in FIG. 4, while the emissivity associated with the surface of a heated substrate within a reflective cavity may vary over a range of about 0.3 to about 0.9 during a coating process, for an overall variation of about 0.6, the effective emissivity of the reflecting cavity may vary over a much smaller range during the coating process, for an overall variation of about 0.23, by way of example. This tends to reduce or minimize uncertainty in the absolute temperature calculation. Still further reductions in this uncertainty are contemplated. For example, it is expected that the emissivity values associated with a bare glass substrate (e.g., in the range of about 0.8 to about 0.9, as mentioned above) will change during a coating process and may be reduced to values of less than about 0.8, but well above about 0.3. If this expectation is realized, the overall variation in the effective emissivity will be less, and the reduction in uncertainty in the temperature calculation will be greater.

The foregoing and particularly its impact on the temperature calculation may be understood by reference to an equation that relates the temperature, T, of a radiator and the thermally radiated power, expressed as radiance, L, of that radiator. Without intending to be limited to any particular theory, in a simplified form, the equation may be expressed as L=(εC1λ⁻⁵)/(e^{-C2/(λ/T)}−1) (Equation 1), where ε is an emissivity of the radiator at a wavelength λ of the calculation, T is the absolute true temperature of the radiator in degrees K, and C1 and C2 are Planck's constants. For an ideal blackbody radiator, as hereinafter represented by the subscript “bb,” ε_{bb} is equal to 1, and for a real radiating body, as hereinafter represented by the subscript “rb,” ε_{rb} is less than 1. For example, as mentioned above, when the real radiating body is glass, as represented by the subscript “g,” ε_{g} is equal to about 0.85 at a wavelength, A, of about 10 μm. When the temperature of a real radiating body, such as glass, is at the same temperature as an ideal blackbody radiator, the radiance of the real radiating body, L_{rb}, is less than the radiance of the ideal blackbody radiator, L_{bb}. The apparent temperature of the real radiating body is defined as the temperature, Tₐₚₚ, at which the radiance of an ideal blackbody radiator, L_{bb}, based on its emissivity, ε_{bb}, of 1, is equal to the radiance of the real radiating body, L_{rb}, based on its emissivity, ε_{rb}, at the true temperature, T, which may be expressed as L_{rb}(ε_{rb}, T)=L_{bb}(1, Tₐₚₚ) (Equation 2). Once L_{rb} and L_{bb} have been equated according to Equation 2, the true temperature, T, may be determined by solving Equation 1 for T, using an L_{bb} value that is measured via a pyrometer, as calibrated using an accepted or laboratory blackbody radiator, and the ε_{rb} value. A variation in the ε_{rb} value will result in a corresponding uncertainty in the calculation of the true temperature, T. A reduction in the range of possible effective emissivity values for the real radiating body, ε_{eff} is thus associated with a reduction in the uncertainty in the calculation of the true temperature, T.

The emissivity of the reflecting cavity may also be affected by characteristics of the transmission of radiation emitted by the substrate 40 within the reflecting cavity via the tubes 26 in the aluminum showerhead 22. In this analysis, the net transmittance of 10 μm-wavelength radiation emitted by a substrate 40 as the radiation passes through a 50 mm-long, 1.27 mm-diameter tube 26 of an aluminum showerhead 22 was calculated and the reflectivity of the surface of the aluminum showerhead was determined.

It was estimated that rays within the reflecting cavity, after having traveled inside the tubular holes 26 in the aluminum showerhead 22 reach the detector over a useful angular range of plus or minus about 8 degrees, defined relative to the central axis of the tubular holes. It was determined that if this angular range were instead defined relative to the inner surface or wall of the tubular holes 26, the range of corresponding angles of incidence defined relative to a direction normal to the surface of the showerhead 22 would be from about 82 to about 90 degrees, where at 90 degrees, the rays are grazing the surface. As shown in FIG. 3, the reflectivity of pure, smooth aluminum is about 0.9 on average over this range.

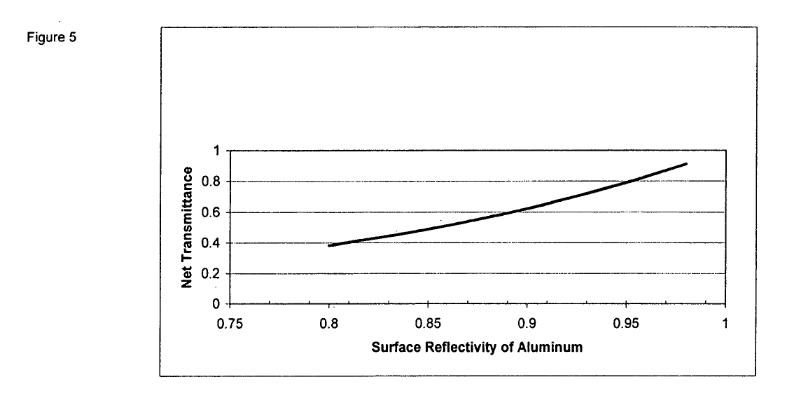

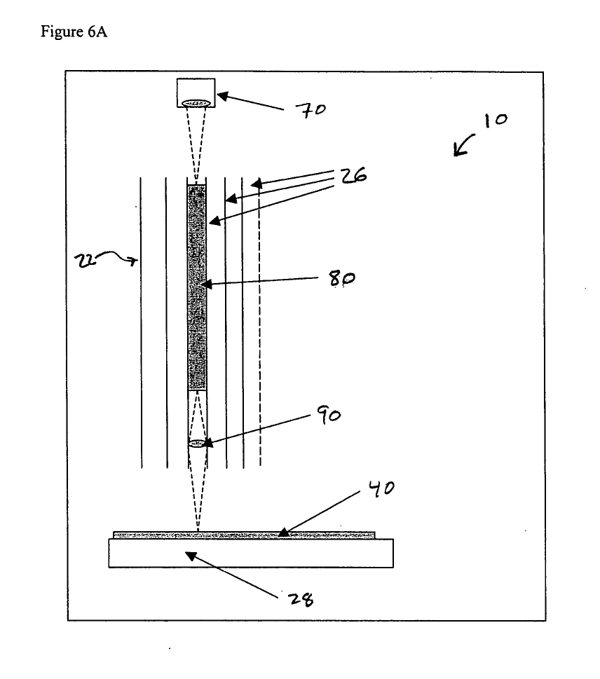

The calculation of transmittance of the tubular holes under the above conditions was performed using an optical ray tracing and analysis program for personal computers, Opticad version 9.0, which allows unconstrained ray paths within the tube. A graphical representation of the calculated net transmittance versus the reflectivity is shown in FIG. 5. It is seen that for a reflectivity of 0.9 estimated for the aluminum surface to represent incidence angles in the range of 82 to 90 degrees, the net transmittance is about 0.6. The calculation for the single tube 26 is applicable to a set of several tubes 26 seen by the pyrometer 50.

The case of net tube transmittance calculated above as shown in FIG. 5 shows that the example combination of tube material, tube length to diameter ratio, and wavelength utilized by the pyrometer 50, the attenuation of radiation leaving the reflecting cavity and passing through the tubes 26 is reduced. This reduction, however, is not so large as to seriously deteriorate the level of signal reaching pyrometer 50, and therefore pyrometer 50 can still deliver a precise reading. The actual losses in such a set of tubes 26 can be calibrated for by means of separate and direct measurement and testing of the actual hardware. Tests can be done by placing a calibrated radiating source at the substrate position and measuring the net pyrometric signal after passing through the tubular holes. Such methods serve to establish a calibrated relationship between substrate emission and the pyrometric signal, thus correcting for the tubular holes in the showerhead.

According to the present invention, the pyrometer 50 that is used to sense the radiation emitted by the substrate 40 receives radiation from several of the tubes 26 or holes 27 in the showerhead 22 at the same time (e.g., two or more, three or more, four or more, five or more, etc.). When this condition is met, the signal is higher, the sampling is better, and the reading may be relatively unaffected by any motion of showerhead 22 relative to pyrometer 50, such that the showerhead and the pyrometer need not be, and/or need not remain, precisely aligned.

According to an example regarding this aspect of the present invention, holes 27 in showerhead 22 are assumed to be in a regular honeycomb or hexagonal pattern, merely by way of example. In this example, each hole measures about 1.27 mm in effective diameter and adjacent holes are spaced about 1 cm apart. The footprint of pyrometer 50 and its aim by optical alignment are selected to ensure that a relatively constant number of holes 27 are seen by the pyrometer at any time and to render this number substantially insensitive to any in-plane motion of the pattern with respect to the centerline of the aim of the pyrometer. This insensitivity to in-plane motion of the pattern requires first insuring that the pyrometer is uniformly sensitive over its viewing area. This uniformity is achieved by correct design of the optics of the pyrometer. In this particular example, the insensitivity to pattern motion may accomplished by selecting a footprint 94 comprising one set of six holes 27 that form a honeycomb or hexagonal pattern 62, as depicted in FIG. 2A. The size of the field aperture 56 is adjusted to limit the field of view of the pyrometer 50 to the selected set of holes 27 and to minimize the space between the selected set of holes and an adjacent set of holes. This limiting of the field of view is such that, should the showerhead 22 move relative to the centerline of the aim of the pyrometer 50, the pyrometer will still see the same number of holes 27. Thus, the pyrometer 50 need not precisely track the movements, however slight, of holes 27 during a coating process. The approach just described may be used in connection with a showerhead 22 that has any suitable number or arrangement of holes 27, such as a single hole, a set of holes in a line, a set of holes in a hole pattern, such as triangular, square, hexagonal, or other regular hole pattern, or multiple sets of holes in any such hole pattern.

During a deposition or coating process, showerhead 22 may be and generally is considerably colder than the heated substrate 40 within the chamber 12. Additionally, if the showerhead 22 is composed of a bare metal, such as aluminum, it may and generally does have an emissivity that is lower than the emissivity of the substrate 40. However, as can be seen in relation to FIG. 1A, the showerhead 22 generally fills the field of view of the pyrometer 50, with an exception as to the area associated with the holes 26 of the showerhead 22. As a result, a signal associated with a portion of the emissivity-enhanced reflecting cavity that is located below the showerhead 22 is comparable in magnitude to a signal associated with the showerhead 22. There are ways to correct for this result according to the present invention.

In one example concerning such a correction, second and third pyrometers are mounted adjacent to a first pyrometer 50 and configured, for example, tilted, so as to look down at the same general area or adjacent area of showerhead 22. The second pyrometer is focused down to a first spot on showerhead 22 that is comparable in diameter to the size of the holes 26 in the showerhead, such as about 1 mm, for example. The third pyrometer is similarly focused nearby at a spot that is removed from the first spot by a distance less than the unit size of the pattern, or the length of one side of a regular pattern, for instance, one-half of it. FIG. 2B is an illustration of such an example, in which the second pyrometer (not shown) is fixed on, or sees, a first spot 96 and the third pyrometer (not shown) is fixed on, or sees, a second spot 98 on showerhead 22, and by virtue of the geometry of this configuration, only one of the first and second spots will correspond to a hole 26 in the showerhead 22 at any one time, whether the showerhead 22 and thus its hole pattern stays in place or moves during a process.

In most cases, the readings of the second and third pyrometers are identical. However, in a case in which one of the second and third pyrometers starts to see a hole 26, as schematically depicted in association with the first spot 96 in FIG. 2B, the reading of that pyrometer will increase. Thus, the pyrometer providing the lower reading of the readings of the second and third pyrometers is the one that does not see a hole.

A simple comparison of the two readings form the second and third pyrometers allows one to pick the lower reading, which can be interpreted, using a selected emissivity correction, to read the true temperature of the showerhead 22. Merely by way of example, an emissivity correction may be selected based on a known emissivity, such as a known emissivity of an aluminum surface 23 of a showerhead 22 associated with 10 μm-wavelength radiation that can be derived from the reflectivity, such as that shown and described in relation to FIG. 3. When the lower reading is subtracted from the reading of the first pyrometer, a reading corresponding to the substrate signal alone is obtained.

Another example regarding the above-described correction is less convenient than, but as useful as, that just described. In this example, only a second pyrometer is needed. The first and second pyrometers are aimed at the same general area of the showerhead 22 and look at areas that are substantially equal in size, as shown in FIG. 1C. The first pyrometer 50 is aimed along a direction of normal incidence relative to the showerhead 22, while aim of the second pyrometer 50′ is along a direction or angle of incidence well in excess of 10 degrees from the aim of the first pyrometer. The second pyrometer 50′ may be tilted or otherwise configured to achieve this aim. The signal that comes up through tubes 26 of showerhead 22 and reaches second pyrometer 50′ is greatly attenuated relative to the signal that comes up through the tubes of the showerhead and reaches the first pyrometer 50, and may be small or negligible. If the signal is small, but still significant, this contribution can be calibrated out by measuring it directly to obtain a value and then subtracting that value from the reading of the first pyrometer 50′. The signal may also be converted from apparent to true temperature by use of the known emissivity of the surface 23 of the showerhead 22 to obtain the showerhead temperature.

In either or both of the correction examples described above, a further correction may be made for any self-emission of the tubular holes 26 of the showerhead 22. This self-emission may be measured, during calibration runs, for example, by placing a surface having very low emissivity, such as an emissivity of less than about 0.03, for example, at the substrate plane. The surface of a gold-coated mirror may be used for this purpose, merely by way of example. The dominant signal is that of the holes 26 alone. The magnitude of this signal can be compared to that of the signal associated with the top 23 of showerhead 22 and used based on the directly calculated proportion of the signal associated with the holes 26 to the signal associated with the hole-free surface 23.

Because the extent of the reflecting cavity 12 is finite, the emissivity of the reflecting cavity is enhanced to a greater extent far from the edges 25 of showerhead 22 than near the edges 25 of showerhead 22. The enhancement of the emissivity of the reflecting cavity 12 also depends on the distance between the reflective bottom face 24 of showerhead 22 and the exposed surface of substrate 40. The emissivity enhancement of the reflecting cavity 12 may be estimated or predicted, empirically evaluated or determined, and incorporated into a correction, to provide a true temperature of substrate 40. Any number of suitable corrections may be employed. Merely by way of example, the correction may be based on a table of values and may be arrived at via an algorithm that is employed by signal processor 80 to obtain a value from such a table of values.

The temperature of a substrate 40 may be bound by extremes that are set by the maximum and minimum emissivities of the substrate during processing. Temperature-correcting algorithms may be adjusted using calibration means that use at least one of two known and regularly occurring emissivities, namely, the emissivity of the surface of the heater 28 devoid of a substrate, and the emissivity of each bare substrate 40 prior to processing. Upon such adjustment, the true emissivity of the surface of the substrate 40 may be determined and employed to calibrate the system.

According to various embodiments of the invention, such as those described above, conditions may be such that the loss of radiation passing through tubes 26 or perforations 27 in showerhead 22 are acceptable. According to other embodiments of the invention, the materials, configurations and geometrical characteristics of the tubes, the wavelength of the light employed, the temperature of the process, and other conditions of the system or process, may be such that the net transmittance associated with a tube 26 or hole 27 in showerhead 22 is considerably lower, such as by a factor of about 50 or more. For example, when the temperature of the process is relatively high, such as about 1000° C., the temperature and/or other optical characteristics of the substrate may best be measured using a pyrometer that operates at wavelengths that are much shorter than about 10 μm, such as about 1 μm or even less, by way of example. In such embodiments, a modified approach that incorporates a more efficient means of passing the thermal radiation of the substrate to the pyrometer using a relay optical system may be employed, as further described below.

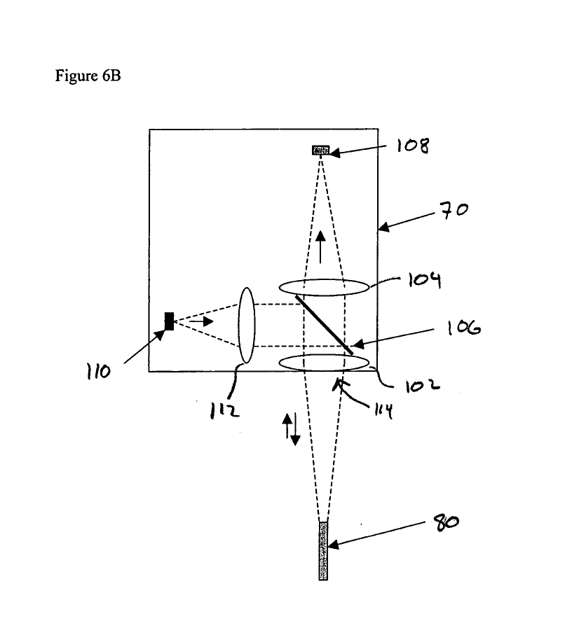

According to such an embodiment of the invention, a deposition system 10, portions of which are shown in FIG. 6A, is provided. The deposition system 10 comprises one or more showerhead(s) 22, a pyrometer-reflectometer instrument 70, and other features previously described in relation to FIG. 1A, although each showerhead 22 has tubular holes 26 that are adjacent one another, or closely packed, as opposed to being well-separated. At least one of these tubular holes 26 is dedicated to the measurement of temperature and/or optical characteristics of a substrate 40, such that it is effectively not used to pass gas within deposition system 10.

The pyrometer-reflectometer instrument 70 comprises a pyrometer and a reflectometer that operate at the same wavelength. This hybrid instrument 70 comprises an optical system that may comprise an objective lens 102, a relay lens 104, a beam splitter 106, a detector 108, a light source 110, such as a laser, a laser diode, a light-emitting diode, an arc lamp, an incandescent lamp, and/or any other suitable light-providing device, and a further lens 112 in the optical pathway between the light source to the beam splitter, as shown in FIG. 6B. Other configurations of the pyrometer-reflectometer instrument 70 are possible and contemplated, including a configuration (not shown) in which only one lens is employed in the optical pathway between the detector 108 and the outlet 114 of the pyrometer-reflectometer instrument 70. In use, light may be allowed to travel from its source 110 to outlet 114 of the pyrometer-reflectometer instrument 70, whereupon it may be directed at either a target surface, such as a substrate 40, or a relay optical element 80, such as a light pipe, to make various measurements as to how the target surface responds to the light, as further described below.

The pyrometer-reflectometer instrument 70 is operated to obtain two types of measurements from the deposition system 10 during a deposition process. One of these is the direct reflectivity of the substrate 40, as may be measured intermittently or continuously during the deposition process via a detector such as the detector already used in the temperature measurement, as the light travels back from the substrate to the pyrometer-reflectometer instrument 70. The other of these is the thermal radiation of the substrate 40, as may be obtained via the detector 108 during the deposition process, as thermal radiation emitted from the substrate back toward the pyrometer-reflectometer instrument 70.

In use, light from a light source, or from an active reflectometer component 110 within the pyrometer-reflectometer instrument 70, such as a laser or an LED light source, is relayed back and forth between the pyrometer-reflectometer instrument 70 and the substrate 40 via the light pipe 80. The thermal radiation from the substrate 40 is collected from the area or over solid angle described above, whereupon it passes through the light pipe 80 and on to the pyrometer-reflectometer instrument 70 for detection. A measurement of the thermal radiation may thus be obtained and used to determine the apparent temperature of the substrate 40. Additionally, a measurement of the reflectivity of the substrate 40 may be obtained and used to compute the true temperature of the substrate 40, via equations and methods previously described.

By virtue of the optical relay element 80, or light pipe, and the lens 90, the pyrometer-reflectometer instrument 70 may be used to look through at least one long tubular hole 27 in a showerhead 22 at a substrate 40 and to perform the normal functions of a pyrometer relative to the substrate 40, such as determining an apparent temperature and a reflectivity of the substrate 40. A length of the light pipe, a focal distance of the lens, and/or other parameters, may be selected as desired, such as to fit a given showerhead design. When such parameters are properly selected, the pyrometer can function well in its normal modes of temperature and reflectivity measurement, and with only a small impact on signal levels, and consequently, on temperature readings and true substrate temperature determinations.

The pyrometer-reflectometer instrument 70 may also be used to detect or measure roughness or any change in roughness of a substrate 40, such as that associated with a deposition process. The roughness may be an inherent quality of the substrate 40 and/or its component materials, or may be the result of phase and/or shape changes associated with the substrate 40 and/or its component materials, that occur during or as a result of a deposition process. The roughness may also correspond to device and/or other features created as part of the fabrication of semiconductor and/or other devices on the substrate 40. Levels of roughness may be measured, calibrated and interpreted in terms useful for process control and verification.

The pyrometer-reflectometer instrument 70 may be used to detect or measure roughness or any change in roughness of a substrate 40 in various ways. One of these ways is based on the depolarization of incident light from pyrometer-reflectometer instrument 70 by substrate 40. In this case, light from the light source 110 is linearly polarized, via use of a linearly polarized light source, such as a laser diode, via use of an unpolarized light source, such as a lamp or a light-emitting diode, and a linear polarizer through which light from the source passes, or via other suitable means or devices, and is allowed to travel to substrate 40. After light returns from the substrate and before it reaches the detector 108, another linear polarizer, situated such that its polarization is orthogonal relative to that of the source, is placed in the return beam such that the polarizers are crossed. When the substrate 40 is, or remains, smooth and optically specular, no light passes to detector 108 by virtue of this crossed polarization. When the substrate is otherwise, some depolarization of the return beam occurs in proportion to the magnitude of the surface roughness, and accordingly, some light passes to the detector 108. Signals from the reflectometer channel that are received by the detector 108 may then be measured. The signals or measurements obtained in this manner may be interpreted as a measure of roughness associated with the surface of the substrate 40. Further, the detector and its output may be calibrated using substrates with independently determined roughness, scattering properties, and the like.

Various references, publications, provisional and/or non-provisional United States patent applications, United States patents, foreign patent applications, and/or foreign patents, have been identified herein, each of which is incorporated herein in its entirety by this reference. Various aspects and features of the present invention have been explained or described in relation to beliefs or theories or underlying assumptions or working or prophetic examples, although it will be understood that the invention is not bound to any particular belief, theory, underlying assumption, or working or prophetic example. Various modifications, processes, as well as numerous structures to which the present invention may be applicable will be readily apparent to those of skill in the art to which the present invention is directed, upon review of the specification. Although the various aspects and features of the present invention have been described with respect to various embodiments and specific examples herein, it will be understood that the invention is entitled to protection within the full scope of the appended claims.

1. A system for measuring the temperature of a substrate through a showerhead used in a deposition system, the system comprising:
at least one opening formed through the showerhead;
a transparent window formed in a wall of the deposition system; and
a first optical temperature measuring device in optical communication with the substrate through the transparent window and an opening in the at least one opening formed in the showerhead, the optical temperature measuring device being configured to measure a temperature of the substrate during processing.

2. The system of claim 1 wherein the showerhead has a plurality of openings formed therein and the first optical temperature measuring device is in optical communication with at least one of the openings in said plurality of openings.

3. The system of claim 1 wherein the first optical temperature measuring device is a pyrometer.

4. The system of claim 1 wherein the first optical temperature measuring device is a reflectometer.

5. The system of claim 1 further comprising a plurality of optical temperature measuring devices to measure the temperature of the substrate, the plurality of optical temperature measuring devices including said first optical temperature measuring devices.

6. The system of claim 1 wherein the first optical temperature measuring device comprises a light source and a detector.

7. The system of claim 6 wherein the light source generates one or more rays of light onto the substrate and the detector receives one or more reflected rays of light from the substrate in order to measure the temperature of the substrate.

8. The system of claim 1 further comprising a light pipe disposed within a first opening, in said at least one opening formed through the showerhead, in order to form an optical pathway between the first optical temperature measuring device and the substrate.

9. The system of claim 8 further comprising a focusing lens disposed within the first opening.

10. The system of claim 1 further comprising a plurality of optical temperature measuring devices and a plurality of transparent windows formed in the wall of the deposition system, wherein the plurality of optical temperature measuring devices includes said first optical temperature measuring device, such that each respective optical temperature measuring device in the plurality of optical temperature measuring devices measures the temperature of the substrate through a corresponding transparent window in the plurality of transparent windows.

11. The system of claim 1 wherein the showerhead is a manifold used to direct gases onto the substrate.

12. The system of claim 1 wherein the first optical temperature measuring device is operated at an operating wavelength in the range of between about 8 μm and about 14 μm when the substrate is at a temperature that is between about ambient temperature and about 500° C.

13. The system of claim 1 wherein the first optical temperature measuring device is operated at an operating wavelength of less than about 1.7 μm when the substrate is at a temperature that is higher than about 100° C.

14. The system of claim 1 wherein the first optical temperature measuring device is operated at an operating wavelength of less than about 1.1 μm when the substrate is at a temperature that is higher than about 300° C.

15. The system of claim 1 wherein a blackbody cavity is formed between the showerhead and the substrate within the deposition system.

16. The system of claim 1 wherein the substrate has an emissivity between about 0.3 and 0.9.

17. The system of claim 1, the system further comprising:
a signal processor in electrical communication with said first optical temperature measuring device, the signal processor for computing the temperature T of the substrate by solving the equation
L=(εC1λ−5)/(e−C2/(λ/T)−1)
where
εis an emissivity of the substrate;
λ is a wavelength measured by the first optical temperature measuring device;
T is the temperature of the substrate in degrees K;
C1 and C2 are Planck's constants;
L is radiance of the substrate as measured by the first optical temperature measuring device.

18. The system of claim 17, wherein the signal processor calibrates L based on a blackbody radiator.

19. The system of claim 1, wherein the at least one opening comprises five or more openings and wherein the first optical temperature measuring device is in optical communication with the substrate through at least five of the five or more openings.

20. The system of claim 1, wherein the at least one opening comprises a plurality of openings arranged in a pattern through said showerhead.

21. The system of claim 1, wherein the pattern is a repeating regular or honeycomb pattern.

22. The system of claim 1, further comprising:
a second optical measuring device in optical communication with a first portion of the showerhead through said transparent window; and
a third optical measuring device in optical communication with a second portion of the showerhead through said transparent window, wherein said first portion and said second portion of the showerhead do not overlap each other.

23. The system of claim 22, further comprising a signal processor in electrical communication with said second optical measuring device and said third optical measuring device, wherein the signal processor is configured to determine the lowest temperature reading between said second optical measuring device and said third optical measuring device and uses this lower temperature reading to provide a true temperature of the showerhead

24. The system of claim 22, wherein the signal processor is in electrical communication with said first optical measuring device and wherein the signal processor corrects the temperature of the substrate using the true temperature of the showerhead.

25. The system of claim 1, wherein
the first optical temperature measuring device is aimed along a direction of normal incidence relative to the showerhead; the system further comprising:
a second optical temperature measuring device in optical communication with the substrate through the transparent window and said opening in the least one opening formed in the showerhead, the second optical temperature measuring device aimed along a direction or angle of incidence in excess of ten degrees from the aim of the first optical temperature measuring device; and
a signal processor in electrical communication with said first optical measuring device and said second optical measuring device, wherein the signal processor is configured to correct the temperature of the substrate, as measured by the first optical measuring device, using a signal measured by the second optical measuring device.

26. A method of measuring the temperature of a substrate during a deposition process, the method comprising the steps of:
forming an optical pathway through a wall of the deposition system;
forming an optical pathway through a showerhead of the deposition system; and
measuring the temperature of the substrate with an optical temperature measuring device with the optical pathway formed in the wall of the deposition system and the showerhead.

27. The method of claim 26 wherein the temperature is measured through a plurality of openings formed in the showerhead.

28. The method of claim 26 wherein a plurality of optical pathways are formed in the wall of the deposition system and the temperature is measured through each optical pathway in the plurality of optical pathways with a respective optical temperature measuring device.

29. The method of claim 26 wherein the optical temperature measuring device is a pyrometer.

30. The method of claim 26 wherein the optical temperature measuring device is a reflectometer.

31. The method of claim 26 wherein the temperature is measured by generating a ray of light onto the substrate through the optical pathway and receiving a reflected ray of light through the optical pathway.

32. The method of claim 26 further comprising the step of inserting a light pipe within the optical pathway formed in the showerhead in order to form the optical pathway.

33. The method of claim 32 further comprising the step of inserting a lens within the opening.

34. A system for measuring the temperature of a substrate being processed in a deposition system having a wall, the system comprising:
a transparent window formed within the wall;
a pyrometer in optical communication with the transparent window;
a showerhead disposed within the deposition system above the substrate, the showerhead having a plurality of openings formed therein, at least one of the openings in optical communication with the transparent window and the pyrometer such that an optical pathway is defined between the substrate and the pyrometer;
wherein the pyrometer measures the temperature of the substrate using the optical pathway.
